(19) United States
(12) Patent Application Publication
(10) Pub. No.: US 2015/0152666 A1
(43) Pub. Date: Jun. 4, 2015

(54) Lock Core with Different Thicknesses of Lock Plates

(71) Applicant: Real Lock & Security Co., Ltd., New Taipei City (TW)

(72) Inventor: I-Hui Ho, New Taipei City (TW)

(73) Assignee: Real Lock & Security Co., Ltd., New Taipei City (TW)

(21) Appl. No.: 14/096,552

(22) Filed: Dec. 4, 2013

(51) Int. Cl. E05B 29/00

(52) U.S. Cl. CPC E05B 29/0013

(57) ABSTRACT

A lock core with different thicknesses of lock plates. The lock core has different lock plates with at least two different thicknesses and specifications. The lock plates are arranged in a core body of the lock core so as to greatly increase the permutation/combination number of the security code and reduce the possibility of repetition of the same unlocking code. Also, this increases the difficulty of finding the correct unlocking positions of the respective lock plates, enhancing the security offered by the device.

### BACKGROUND OF THE INVENTION

1. Field of the Invention

The present invention relates to a lock core with different thicknesses of lock plates (or disks). The lock plates have at least two different thicknesses and specifications and are arranged in a core body of the lock core so as to greatly increase the permutation/combination numbers of the security code and reduce the possibility of repetition of the same unlocking code. Also, this increases the difficulty for a thief to find the unlocking positions of the respective lock plates, whereby the burglarproof and security effect is enhanced.

2. Description of the Related Art

The lock core structure of the current lock device generally includes a main body and a core body rotatably mounted in the main body. A lock bolt is mounted between the core body and the main body. A true key can be used to drive the lock bolt so as to unlock the core body from the main body. In this case, the core body can be freely rotated within the main body to unlock.

The early-stage lock device has a lock bolt in the form of multiple pairs of lock beads. The lock beads are radially mounted between the main body and the core body via springs. A true key can be used to shift the lock beads to the junction face between the main body and the core body to unlock the main body from the core body. Under such circumstance, the true key can drive and rotate the core body to unlock the lock device. However, with respect to the lock core with the lock beads, a thief can apply a rotational force to the core body to shift the respective rows of lock beads one by one with a tool and then easily unlock the lock device. Therefore, the burglarproof and security effect of such lock device is quite weak.

To solve the above problems, the applicant's Taiwanese Utility Model Patent Publication No. 088732 (Application Date: 1986 May 3) discloses a lock core structure as shown in FIG. 1. The lock core structure includes a main body 101, a core body 102, a lock bolt 103 and multiple lock plates 104. The core body 102 is mounted in the main body 101 and normally latched with the main body 101 by means of the lock bolt 103 without possibility of rotation (as shown in FIG. 2). When a true key K is inserted into the lock plates 104 and rotated, the unlocking recesses 104a of the lock plates 104 are respectively aligned with the lock bolt 103 as shown in FIG. 3, whereby the lock bolt 103 is slid into the unlocking recesses 104a of the lock plates 104 and retracted into the core body 102 so as to unlock the core body 102 from the main body 101. When rotating the core body 102 as shown in FIG. 4, the protruding key 104b of at least one lock plate 104 drives the core body 102 to rotate so as to unlock the lock device. According to the above structure, the unlocking recesses 104a are distributed over a 360-degree range of the periphery of the lock plate 104 and some of the lock plates 104 can self-rotate within the main body 10 so that the difficulty for a thief to find the true unlocking position is greatly increased and the burglarproof and security effect is enhanced relative to the conventional lock core with lock beads.

However, when a thief tries to unlock the lock device, the thief will generally use a tool to shift the lock plates 104 one by one. Under the assistance of the thief's own experience or an electronic device, the thief may still find the correct unlocking positions of the lock plates 104 with patience and time to unlock the lock device. This is because the lock plates 104 arranged in the core body 102 have the same thickness. A thief can easily obtain a conventional lock device in the market to learn the thickness of the lock plates 104 from the obtained lock device. In this case, the thief can advance the tool each time by a distance equal to the thickness of the lock plates to precisely align the tool with the positions of each lock plate 104 and correctly shift the lock plates 104 to unlock the lock device. It is therefore an object of the invention by the applicant to provide a lock core with different thicknesses of lock plates to increase the difficulty of unlocking the lock device via lockpicking.

### SUMMARY OF THE INVENTION

It is therefore a primary object of the present invention to provide a lock core with different thicknesses of lock plates. The lock core includes a main body; a core body rotatably mounted in the main body, the core body being axially recessed to form a receiving cavity; a lock bolt normally positioned between the core body and the main body for restricting the core body from rotating; and multiple lock plates having at least two different thicknesses and specifications, the lock plates being side by side arranged in the core body and drivable by a true key to retract the lock bolt into the core body so as to unlock the main body from the core body, whereby the core body can be freely rotated within the main body to unlock. The lock plates arranged in the core body have at least two different thicknesses and specifications. Therefore, a thief cannot find the correct arrangement intervals between the lock plates. In this case, it is impossible for the thief to position a tool in a correct corresponding position of the lock plates to shift the lock plates one by one. Moreover, when the thief tries to shift a thin lock plate with a tool of a width larger than the thickness of the thin lock plate, the thief will also drive the other lock plates immediately adjacent to the thin lock plate. Therefore, it is very hard for the thief to find the correct unlocking position of the lock plates so that the burglarproof and security effect is enhanced.

In the above lock core with different thicknesses of lock plates, the main body is formed with an axial socket. A wall of the axial socket is formed with a latch cavity. One end of the core body is axially recessed to form a receiving cavity for receiving the lock plates, whereby the lock plates are arranged in the receiving cavity. A drive slot and a bolt slot are formed on the receiving cavity. The lock bolt is normally positioned between the latch cavity and the bolt slot. Each of the lock plates is axially formed with a keyhole. A periphery of each lock plate is formed with an unlocking recess, whereby the lock bolt can be slid into the unlocking recesses. The periphery of at least one of the lock plates is formed with a protruding key.

In the above lock core with different thicknesses of lock plates, the face of the true key is formed with at least two kinds of parallel dents with different thicknesses and specifications corresponding to the arrangement positions of the lock plates. Accordingly, the true key can shift the corresponding lock plates respectively to unlock.

In the above lock core with different thicknesses of lock plates, different numbers of thick and thin lock plates are selectively arranged in the receiving cavity of the core body in different permutation/combination patterns. Therefore, the total number of the lock plates and the arrangement manner of the lock plates are varied to increase the difficulty for a thief to find the correct unlocking position and unlock the lock device. Moreover, the number of permutation/combination of the security code of the lock core is increased to greatly reduce the possibility of repeat of the same unlocking code.

In the above lock core with different thicknesses of lock plates, a bottom end of the receiving cavity of the core body is formed with a key cave, whereby a front end of the true key can be inserted into the key cave and rotated within the key cave. When the front end of the true key abuts against the bottom of the key cave, the dents of the true key are such positioned as to be precisely aligned with the lock plates respectively. Accordingly, the depth of the key cave can be varied in cooperation with the total number of the thick and thin lock plates and the arrangement manner thereof so as to increase the combination number of the security code of the lock device and increase the difficulty for a thief to unlock the lock device.

The lock core with different thicknesses of lock plates of the present invention is structurally characterized in that different thicknesses and specifications of lock plates are arranged in the core body. The present invention has the following advantages:

1. The lock plates have different thicknesses and are randomly arranged so that a thief cannot find the intervals between the lock plates. That is, the thief cannot position the tool in a correct position to shift the lock plates. Therefore, the difficulty for the thief to unlock the lock device is greatly increased.
2. When a thief uses a tool to shift a certain lock plate, it is very likely for the thief to drive the other lock plates immediately adjacent to the lock plate. Therefore, it is very hard for the thief to shift the lock plates to the correct unlocking positions. This enhances the burglarproof and security effect of the present invention.
3. The lock plates have at least two different thicknesses and specifications. The lock plates can be arranged in different manners to form different unlocking codes. Accordingly, the number of permutation/combination of the security code is greatly increased to reduce the possibility of repetition of the same unlocking code.
4. The present invention includes different thicknesses of lock plates. Therefore, in condition of same depth of receiving cavity, the total number of the lock plates will be larger than that of the lock plates with the same thickness of the conventional lock device. The increase of the total number of the lock plates will lead to increase of the number of permutation/combination of the security code of the present invention, whereby the possibility of repeat of the same unlocking code is reduced and the difficulty for a thief to unlock the lock device is greatly increased.

The present invention can be best understood through the following description and accompanying drawings, wherein:

### BRIEF DESCRIPTION OF THE DRAWINGS

FIG. 1 is a perspective exploded view of a conventional lock core structure;

FIG. 2 is a sectional view showing that the conventional lock core structure is in a locked state;

FIG. 3 is a sectional view showing that the conventional lock device structure is in an unlocked state;

FIG. 4 is a sectional view according to FIG. 3, showing that the core body is rotated to unlock the lock device;

FIG. 5 is a perspective exploded view of a first embodiment of the present invention;

FIG. 6 is a perspective assembled view of the first embodiment of the present invention;

FIG. 7 is a perspective partially sectional view of the first embodiment of the present invention;

FIG. 8 is a sectional view taken along line 8-8 of FIG. 6;

FIG. 9 is a sectional view showing that a true key is fully inserted into the core body of the present invention;

FIG. 10 is a sectional view showing that a false key is fully inserted into the core body of the present invention;

FIG. 11 is a sectional view showing that a thief uses a tool to shift one of the lock plates of the present invention;

FIG. 12 is a sectional view according to FIG. 11, showing that when one lock plate is rotated, another lock plate is also driven and rotated;

FIG. 13 shows the relationship between the true key for unlocking the present invention and the lock plates; and

FIG. 14 is a perspective exploded view of a second embodiment of the present invention.

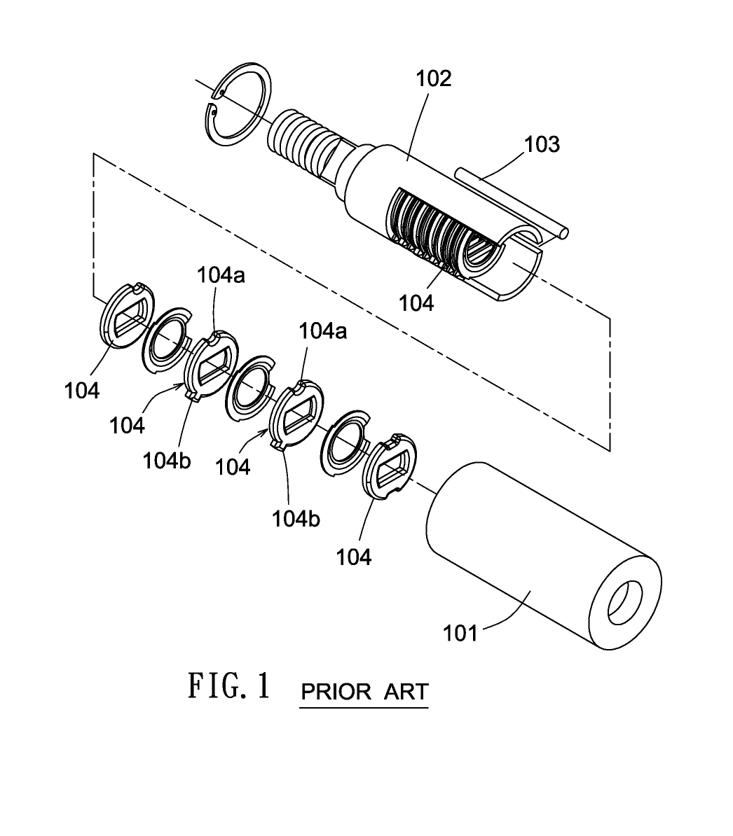

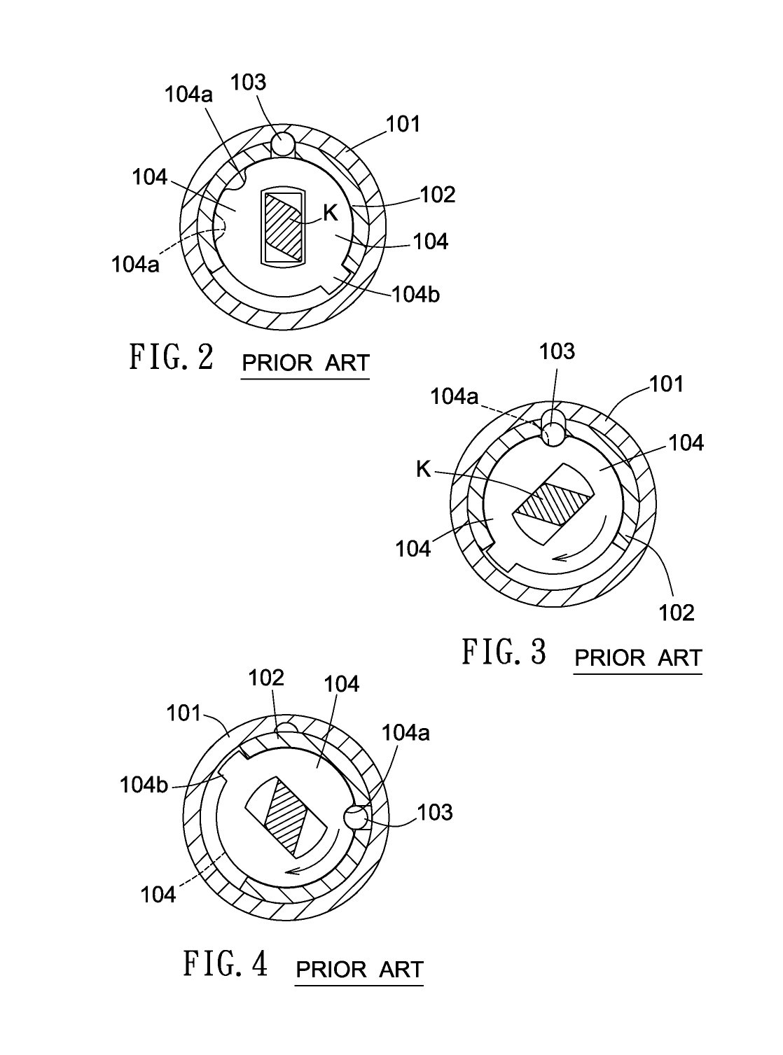

### DETAILED DESCRIPTION OF THE PREFERRED EMBODIMENTS

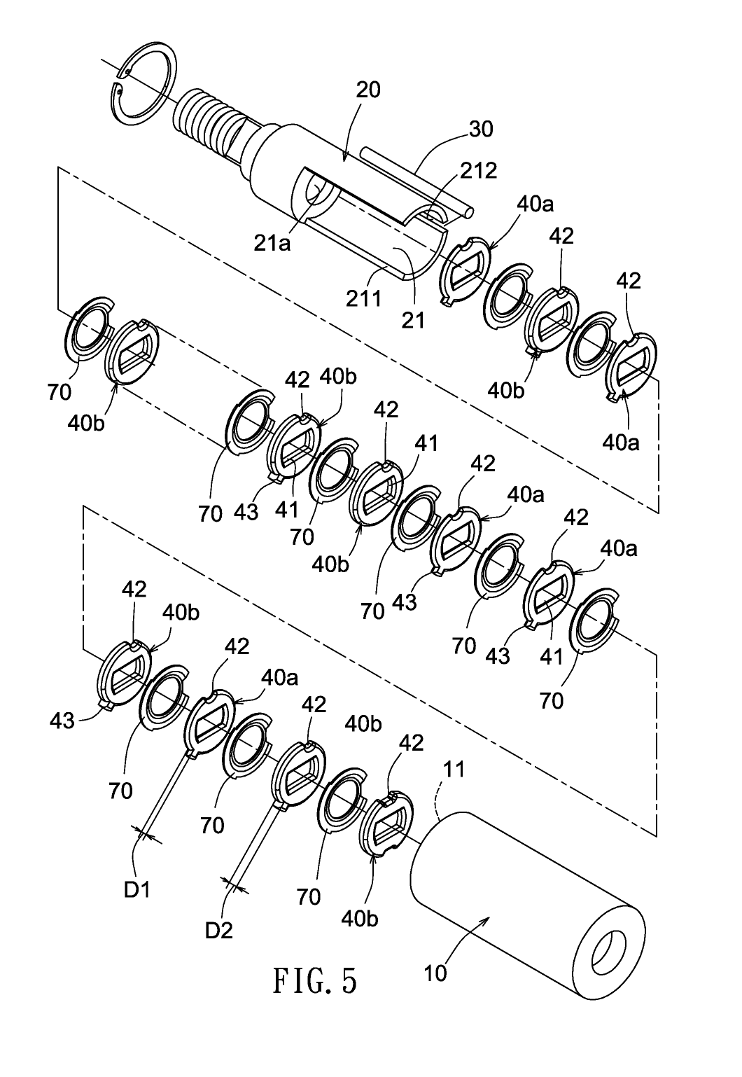

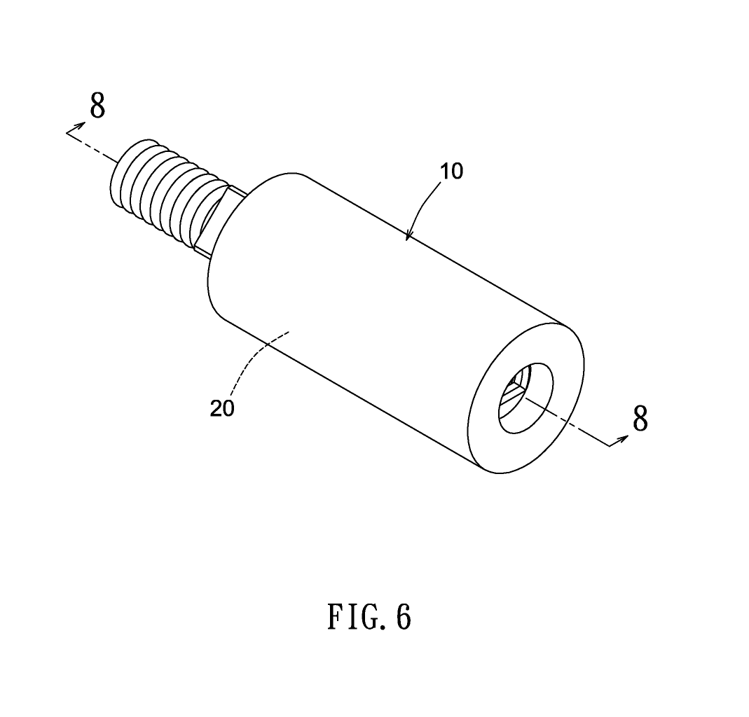

Please refer to FIGS. 5, 6, 7 and 8. The present invention relates generally to a lock core with different thicknesses of lock plates. Different lock plates 40a, 40b with different thicknesses and specifications are arranged in the core body 20 of the lock core so as to greatly increase the permutation/combination number of the security code and reduce the possibility of repeat of the same unlocking code. Also, this increases the difficulty for a thief to find the true unlocking positions of the respective lock plates 40a, 40b, whereby the burglarproof and security effect is enhanced.

The lock core with different thicknesses of lock plates of the present invention includes a main body 10, a core body 20 rotatably mounted in the main body 10 and normally latched with the main body 10 by means of a lock bolt 30, and multiple lock plates 40a, 40b with at least two different thicknesses and specifications. (For example, as shown in FIG. 5, the thin lock plates are denoted with 40a and the thickness thereof is D1, while the thick lock plates are denoted with 40b and the thickness thereof is D2, wherein D2>D1). The lock plates 40a, 40b are side by side arranged in the core body 20. A correct key 50 can be used to drive the lock bolt 30 into the core body 20 so as to unlock the main body 10 from the core body 20. Under such circumstance, the core body 20 can be freely rotated within the main body 10 to unlock.

The lock plates 40a, 40b in the core body 20 have at least two different thicknesses and specifications. The lock plates are randomly arranged and combined so that a thief cannot find the arrangement intervals between the lock plates 40a, 40b, that is, the thief cannot position a tool in a correct position corresponding to the respective lock plates 40a, 40b to shift the lock plates 40a, 40b one by one. In the case that the thief shifts a thin lock plate 40a with a tool 60 wider than the thin lock plate, the tool will also drive the other lock plates 40a or 40b immediately adjacent to the thin lock plate 40a. As a result, the thief cannot successfully find the correct unlocking position of the respective lock plates 40a, 40b so that the burglarproof and security effect is enhanced.

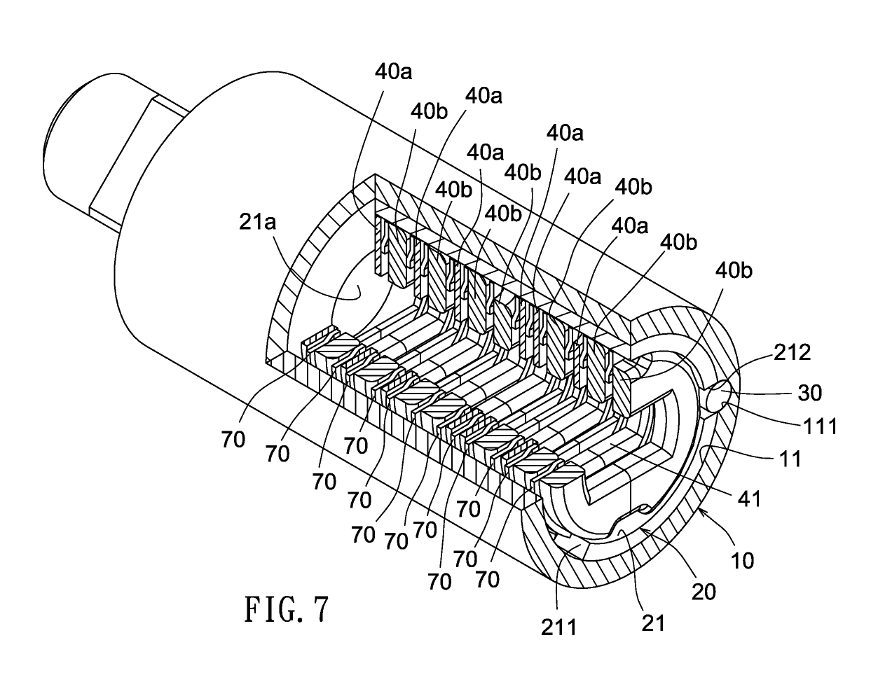

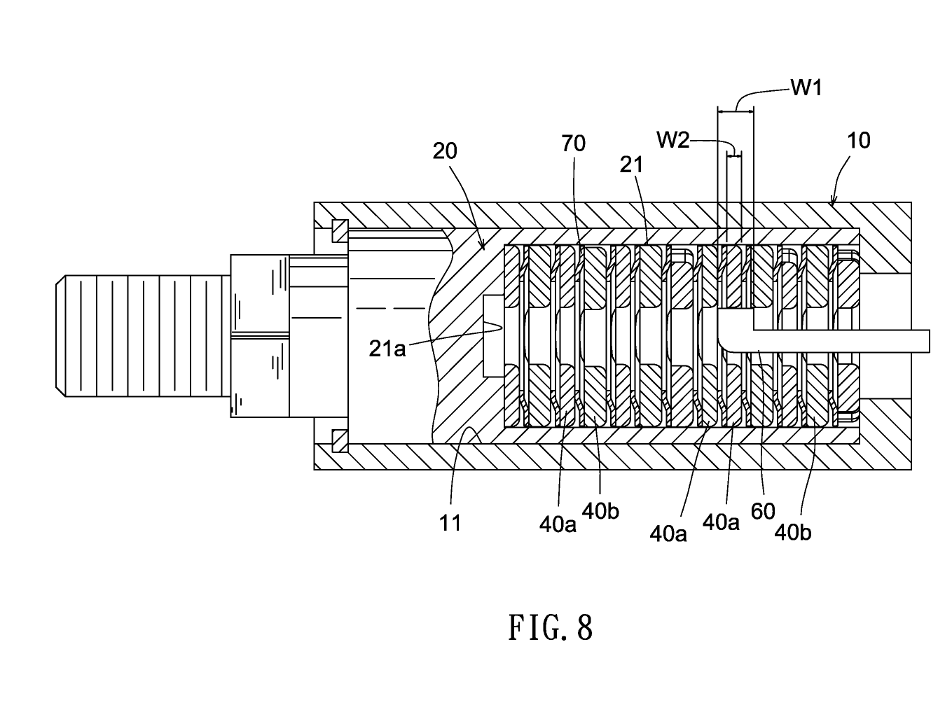

As shown in FIGS. 7 and 8, in the lock core with different thicknesses of lock plates of the present invention, the respective lock plates 40a, 40b can be arranged in the core body 20 in a random sequence. Alternatively, the thick lock plates 40b can be arranged in sequential positions of odd numbers, while the thin lock plates 40a are arranged in sequential positions of even numbers. The arrangement manner of the lock plates is not limited. Accordingly, the lock plates are irregularly arranged to increase the difficulty for a thief to find the true unlocking positions of the respective lock plates. Also, the permutation/combination number of the security code of the present invention is increased to reduce the possibility of repetition of the same unlocking code.

Referring to FIGS. 5, 7 and 8, in the lock core with different thicknesses of lock plates of the present invention, the main body 10 is formed with an axial socket 11. The wall of the axial socket 11 is formed with a latch cavity 111 for the lock bolt 30 to extend therein. One end of the core body 20 is axially recessed to form a receiving cavity 21 for receiving the lock plates 40a, 40b, whereby the lock plates 40a, 40b can be arranged in the receiving cavity 21. In addition, a drive slot 211 and a bolt slot 212 are formed on the receiving cavity 21. The protruding keys 43 of the lock plates 40a, 40b extend into the drive slot 211, while the lock bolt 30 is slidable into the bolt slot 212.

As shown in FIG. 5, the lock plates 40a, 40b are axially formed with a keyhole 41. The peripheries of the lock plates 40a, 40b are formed with unlocking recesses 42. The lock bolt 30 can be slid into the unlocking recesses 42. The periphery of at least one of the lock plates 40a or 40b is formed with the protruding key 43 extending into the drive slot 211 of the core body 20 for driving and rotating the core body 20.

Referring to FIG. 5, in the lock core with different thicknesses of lock plates of the present invention, the lock bolt 30 is in the form of a circular rod. At normal time, the lock bolt 30 is positioned between the latch cavity 111 of the main body 10 and the bolt slot 212 of the core body 20 for preventing the core body 20 from rotating within the main body 10. When a user uses a true key 50 to shift the lock plates 40a, 40b to a correct position, the unlocking recesses 42 of the lock plates 40a, 40b are aligned with the bolt slot 212 of the core body 20 and the protruding key 43 of at least one lock plate 40a, 40b is leant against one side of the drive slot 211 of the core body 20. Under such circumstance, when the true key 50 is further rotated to drive and rotate the core body 20, the lock bolt 30 is forced into the bolt slot 212 and the unlocking recesses 42 of the lock plates 40a, 40b. Accordingly, the lock bolt 30 is totally retracted into the core body 20. In this case, the core body 20 can be freely rotated within the main body 10 to unlock.

In the lock core with different thicknesses of lock plates of the present invention, the number of the thick lock plates 40a can be different from the number of the thin lock plates 40b. The different numbers of lock plates 40a, 40b can be randomly arranged to greatly increase the difficulty for a thief to find the true unlocking positions of the respective lock plates. Also, the permutation/combination number of the security code of the lock core is increased to greatly reduce the possibility of repetition of the same unlocking code.

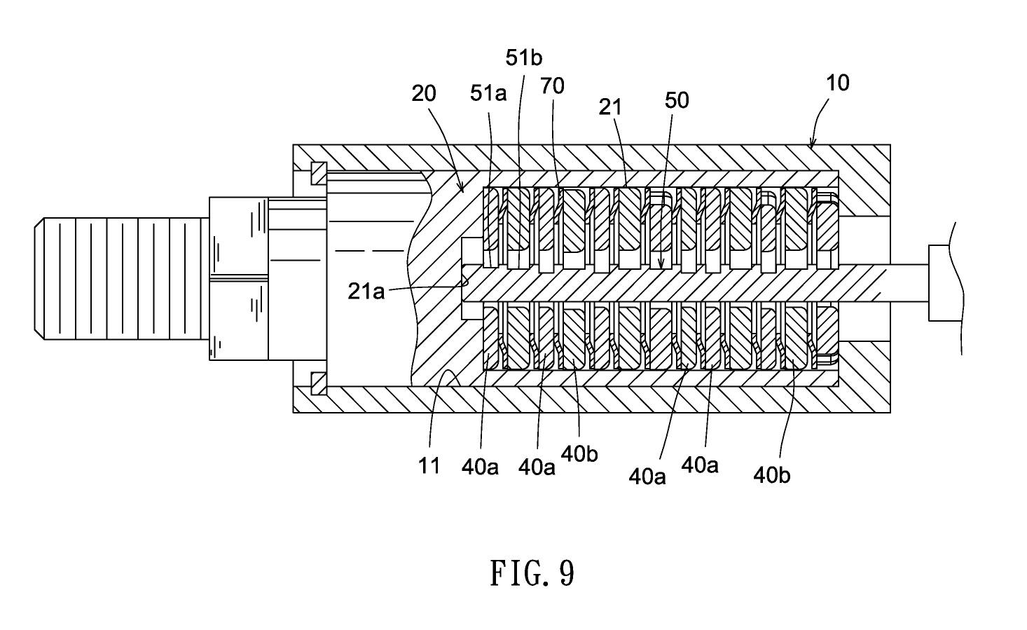

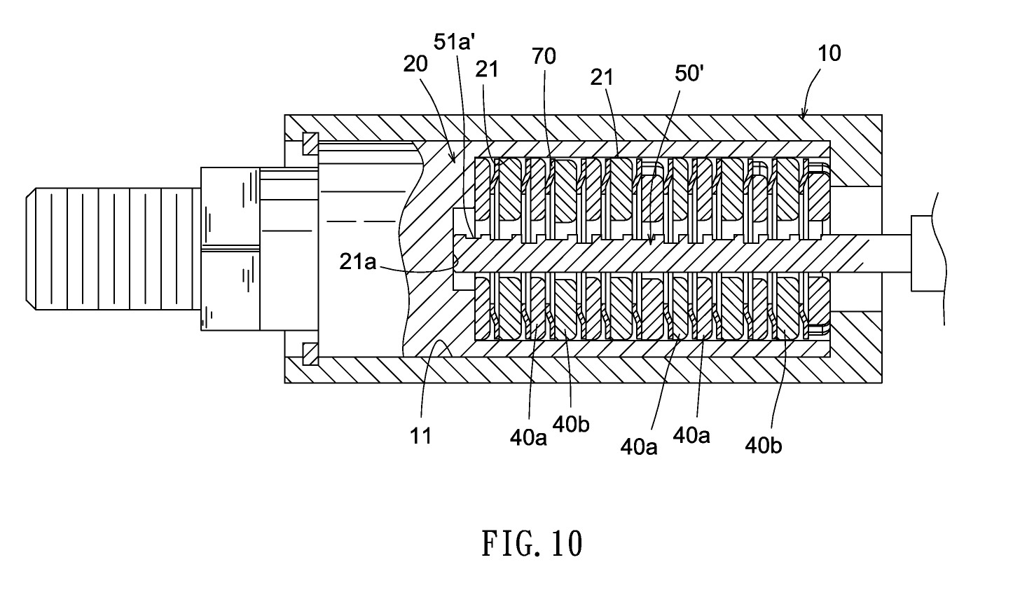

Referring to FIGS. 8 and 9, in the lock core with different thicknesses of lock plates of the present invention, the bottom end of the receiving cavity 21 of the core body 20 is formed with a key cave 21a. A front end of the true key 50 can be inserted into the key cave 21a and rotated within the key cave 21a. When the front end of the true key 50 abuts against the bottom of the key cave 21a, the dents 51a, 51b of the true key 50 are such positioned as to be precisely aligned with the lock plates 40a, 40b respectively. Accordingly, the depth of the key cave 21a can be varied in cooperation with the total number of the thick and thin lock plates 40a, 40b and the arrangement manner thereof so as to increase the combination number of the security code of the lock device and increase the difficulty for a thief to unlock the lock device. As shown in FIG. 10, in the manufacturing process of the key 50′, in the case that the distance H between the first dent 51a′ and the front end of the key 50′ is unequal to the depth of the key cave 21a, it will be impossible to align the dents 51 with the lock plates 40a, 40b so that it is impossible to unlock. Accordingly, the depth of the key cave 21a is also a component of the security code of the lock core of the present invention. This enhances the burglarproof and security effect of the present invention.

In the lock core with different thicknesses of lock plates of the present invention, a spacer plate 70 is disposed between two adjacent lock plates 40a or 40b to space the two adjacent lock plates 40a, 40b from each other. The periphery of the spacer plate 70 is formed with a flange 71 for reducing the friction between the two adjacent lock plates 40a, 40b and smoothening the relative rotation of the lock plates 40a, 40b.

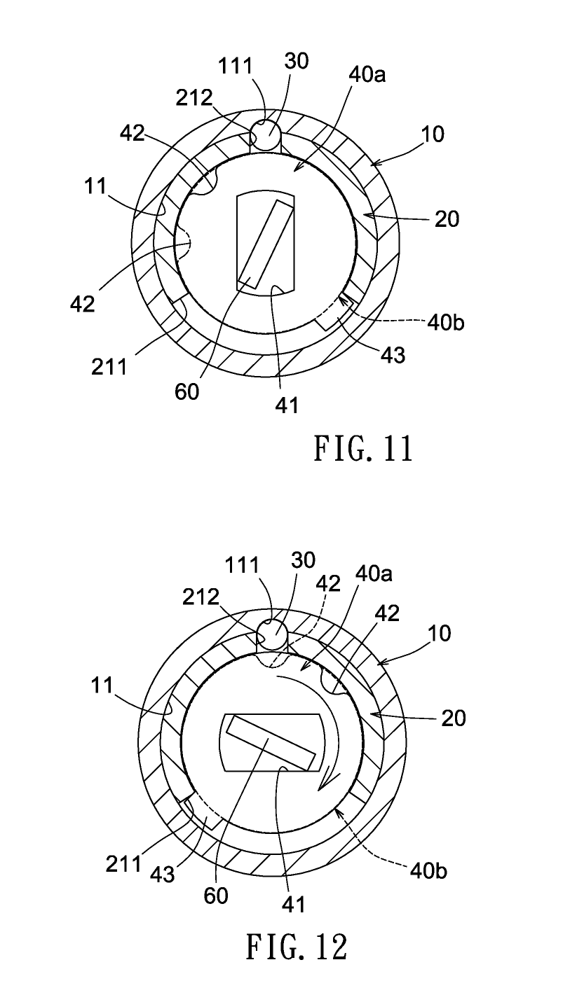

When a thief tries to one by one shift the lock plates 40a, 40b in the core body 20 with a tool 60 having a width W1 larger than the thickness W2 of the thin lock plate 40a, in the case that the tool 60 is used to shift the thin lock plate 40a (as shown by the solid lines of FIGS. 11 and 12), the tool 60 will also shift the other lock plates 40b adjacent to the thin lock plate 40a (as shown by the phantom lines of FIGS. 11 and 12). Therefore, it is impossible to shift the lock plates 40a, 40b one by one. Under such circumstance, the thief will be unable to find the correct unlocking code so that the burglarproof and security effect of the present invention is enhanced.

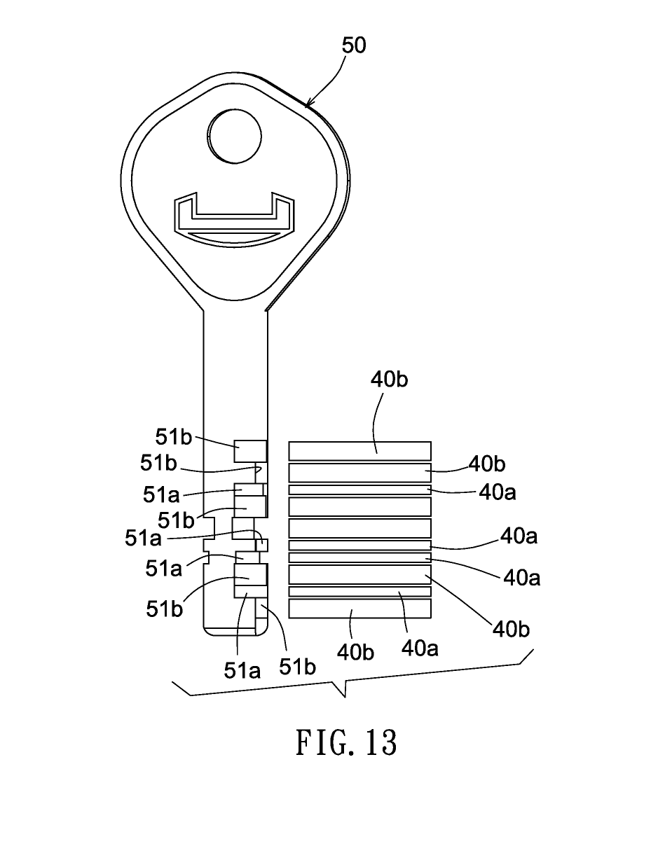

Referring to FIG. 13, the face of the true key 50 is formed with multiple parallel dents 51a, 51b corresponding to the positions and widths of the lock plates 40a, 40b arranged in the core body 10. Accordingly, after rotating the true key 50, the corresponding lock plates 40a, 40b are respectively shifted to unlock. That is, the face of the true key 50 is formed with at least two kinds of parallel dents 51a, 51b with different widths and specifications. This is different from the current key simply formed with dents of equal width. In this case, it is impossible for a thief to use a common copying machine to copy the true key of the present invention.

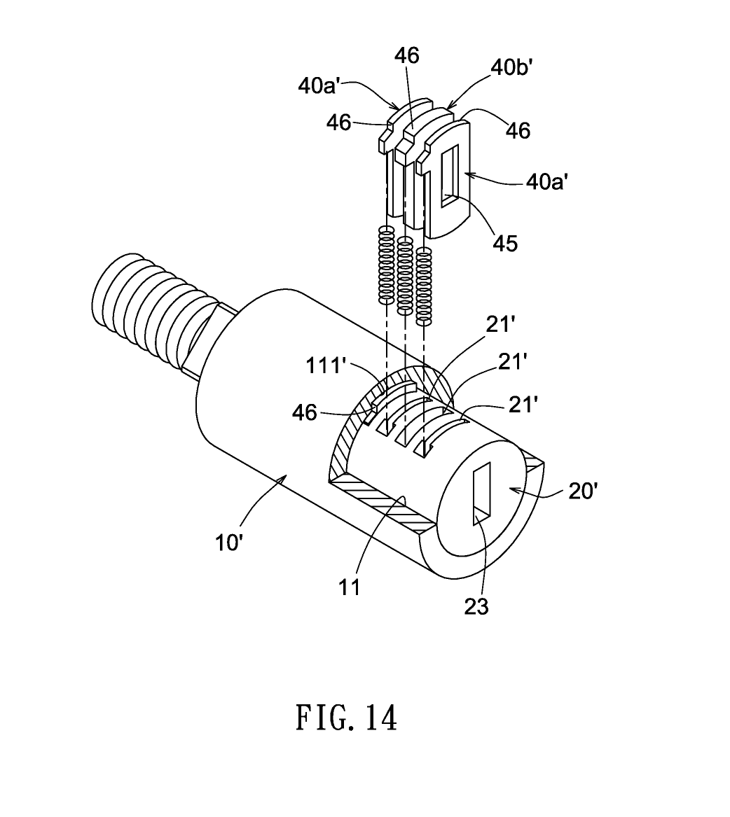

Please now refer to FIG. 14, which shows a second embodiment of the lock core with different thicknesses of lock plates of the present invention. The second embodiment includes a main body 10′ formed with an axial socket 11. The wall of the axial socket 11 is formed with a latch cavity 111′. The second embodiment further includes a core body 20′ rotatably mounted in the axial socket 11 of the main body 10′. The core body 20′ is axially formed with a key socket 23. In addition, the core body 20′ is formed with multiple radial receiving slots 21′. Multiple lock plates 40a′, 40b′ are arranged in the receiving slots 21′. Springs 44 are installed in the receiving slots 21′ corresponding to the lock plates 40a′, 40b′ for elastically radially outward pushing the lock plates 40a′, 40b′. The lock plates 40a′, 40b′ have at least two different thicknesses and specifications. The lock plates 40a′, 40b′ are axially formed with keyholes 45 respectively. A lock bolt 46 is formed on a periphery of each of the lock plates 40a′, 40b′ and protrudes therefrom. The lock bolt can correspondingly extend into the latch cavity 111′ of the main body 10′ to lock the main body 10′ with the core body 20′. When a true key is inserted into the keyholes 45 of the lock plates 40a′, 40b′, the lock bolts 46 of the lock plates 40a′, 40b′ are driven to totally retract into the core body 20′ so as to unlock. The lock plates 40a′, 40b′ have at least two different specifications and thicknesses so that the numbers of the lock plates 40a′, 40b′ can be changed and the lock plates 40a′, 40b′ can be permuted and combined in different manners to form different unlocking codes. Accordingly, more permutation/combination patterns can be achieved to increase the number of permutation/combination of the security code of the present invention and reduce the possibility of repeat of the same unlocking code.

The lock core with different thicknesses of lock plates of the present invention is structurally characterized in that at least two different thicknesses and specifications of lock plates 40a, 40b are arranged in the core body. The present invention has the following advantages:

1. The lock plates 40a, 40b have different thicknesses and are randomly arranged so that a thief cannot find the intervals between the lock plates 40a, 40b. That is, the thief cannot position the tool 60 in a correct position to shift the lock plates 40a, 40b. Therefore, the difficulty for the thief to unlock the lock device is greatly increased.
2. When a thief uses a tool to shift a certain lock plate 40a or 40b, it is very likely for the thief to drive the other lock plates 40a or 40b immediately adjacent to the lock plate. Therefore, it is very hard for the thief to shift the lock plates 40a, 40b to the correct unlocking positions. This enhances the burglarproof and security effect of the present invention.
3. The lock plates 40a, 40b have at least two different thicknesses and specifications. The lock plates 40a, 40b can be arranged in different manners and the total number of the lock plates 40a, 40b can be changed to form different unlocking codes. Accordingly, the number of permutation/combination of the security code is greatly increased to reduce the possibility of repetition of the same unlocking code.
4. The present invention includes different thicknesses of lock plates 40a, 40b. Therefore, in condition of same depth of receiving cavity 21, the total number of the lock plates 40a, 40b will be larger than that of the lock plates with the same thickness of the conventional lock device. The increase of the total number of the lock plates 40a, 40b will lead to increase of the number of permutation/combination of the security code of the present invention, whereby the possibility of repetition of the same unlocking code is reduced and the difficulty for a thief to unlock the lock device is greatly increased.

The above embodiments are only used to illustrate the present invention, not intended to limit the scope thereof. Many modifications of the above embodiments can be made without departing from the spirit of the present invention.

What is claimed is:

1. A lock core with different thicknesses of lock plates, comprising:
a main body;
a core body rotatably mounted in the main body, the core body being axially recessed to form a receiving cavity;
a lock bolt normally positioned between the core body and the main body for restricting the core body from rotating; and
multiple lock plates having at least two different thicknesses and specifications, the lock plates being side by side arranged in the core body and drivable by a true key to retract the lock bolt into the core body so as to unlock the main body from the core body, whereby the core body can be freely rotated within the main body to unlock.

2. The lock core with different thicknesses of lock plates as claimed in claim 1, wherein the lock plates with at least two different thicknesses and specifications are sequentially randomly arranged in the core body.

3. The lock core with different thicknesses of lock plates as claimed in claim 1, wherein the main body is formed with an axial socket, a wall of the axial socket being formed with a latch cavity, one end of the core body being axially recessed to form a receiving cavity for receiving the lock plates, whereby the lock plates are arranged in the receiving cavity, a drive slot and a bolt slot being formed on the receiving cavity, the lock bolt being normally positioned between the latch cavity and the bolt slot, each of the lock plates being axially formed with a keyhole, a periphery of each lock plate being formed with an unlocking recess, whereby the lock bolt can be slid into the unlocking recesses, the periphery of at least one of the lock plates being formed with a protruding key, a spacer plate being disposed between each two adjacent lock plates.

4. The lock core with different thicknesses of lock plates as claimed in claim 1, wherein a bottom end of the receiving cavity of the core body is formed with a key cave, whereby a front end of the true key can be inserted into the key cave and rotated within the key cave.

5. The lock core with different thicknesses of lock plates as claimed in claim 1, wherein a face of the true key is formed with at least two kinds of parallel dents with different thicknesses and specifications.

6. The lock core with different thicknesses of lock plates as claimed in claim 1, wherein the main body is formed with an axial socket, a wall of the axial socket being formed with a latch cavity, the core body being rotatably mounted in the axial socket of the main body, the core body being axially formed with a key socket, the core body being further formed with multiple radial receiving slots, the lock plates being arranged in the receiving slots, springs being installed in the receiving slots corresponding to the lock plates for elastically radially outward pushing the lock plates, the lock plates having at least two different thicknesses and specifications, the lock plates being axially formed with keyholes respectively, a lock bolt being formed on a periphery of each of the lock plates and protruding therefrom, whereby the lock bolt can correspondingly extend into the latch cavity of the main body to lock the main body with the core body, when a true key is inserted into the keyholes of the lock plates, the lock bolts of the lock plates being driven to totally retract into the core body so as to unlock.
